(19) United States
(12) Patent Application Publication
(10) Pub. No.: US 2026/0064441 A1
(43) Pub. Date: Mar. 5, 2026

(54) DETECTING USER INACTIVITY IN A MULTIPROCESSOR COMMUNICATION DEVICE

(71) Applicant: MOTOROLA SOLUTIONS, INC., Chicago, IL (US)

(72) Inventors: David J. Ley, Plantation, FL (US); Mark Antilla, Davie, FL (US); Sean Regan, Delray Beach, FL (US)

(21) Appl. No.: 18/820,664

(22) Filed: Aug. 30, 2024

(51) Int. Cl. G06F 9/451; G06F 1/3231; G06F 3/02; G06F 3/0362; G06F 3/0488; G08B 21/18

(52) U.S. Cl. CPC G06F 9/451; G06F 1/3231; G08B 21/18; G06F 3/02; G06F 3/0362; G06F 3/0488

(57) ABSTRACT

Examples include a communication device including a user interface (UI), a first electronic processor configured to detect and process UI input events, and a second electronic processor communicatively connected to the first electronic processor and configured to detect and process UI input events. The first electronic processor executes an application having a user inactivity timeout feature by initializing a countdown timer for a first time period, and, in response to expiration of the countdown timer, determining a user inactivity time for the communication device. The user inactivity time is a lesser of a time since a UI input event was last detected by the first electronic processor and a time since a UI input event was last detected by the second electronic processor. In response to the user inactivity time being greater than or equal to the first time period, the first electronic processor performs an application timeout function.

### BACKGROUND

Examples described herein relate to multiprocessor communication devices, such as portable multiprocessor two-way radio communication devices (sometimes referred to as “radios”).

### BRIEF DESCRIPTION OF THE DRAWINGS

FIG. 1 schematically illustrates a multiprocessor communication device, according to some examples.

FIG. 2 illustrates a method for managing user inactivity during execution of an application by a first processor of a multiprocessor device, according to some examples.

FIG. 3 illustrates a method for managing user inactivity during execution of an application by a second processor of a multiprocessor device, according to some examples.

FIG. 4 illustrates a method for detecting user activity in a multiprocessor device in response to performing a user inactivity timeout function, according to some examples.

FIG. 5 illustrates a method for managing user inactivity in a multiprocessor device in response to performing a user inactivity timeout function, according to some examples.

Skilled artisans will appreciate that elements in the figures are illustrated for simplicity and clarity and have not necessarily been drawn to scale. For example, the dimensions of some of the elements in the figures may be exaggerated relative to other elements to help improve understanding of examples of the present disclosure.

The system, apparatus, and method components have been represented where appropriate by conventional symbols in the drawings, showing only those specific details that are pertinent to understanding the examples of the present disclosure so as not to obscure the disclosure with details that will be readily apparent to those of ordinary skill in the art having the benefit of the description herein.

### DETAILED DESCRIPTION

Applications that are run on conventional mobile devices often have user inactivity timeout features in which a processor of the mobile device performs a particular user interface (UI) control when the device has not been used (e.g., user input has not been received via the UI) for a predetermined amount of time. Such user inactivity timeout features include, for example, dimming or turning off the display of the mobile device, playing a feedback tone through a speaker of the mobile device, or the like.

Some multiprocessor communication devices, such as smart radios, have multiple inactivity subsystems each controlled by a respective processor that detect separate user input events from one another. For example, a first user inactivity timer of a first user inactivity subsystem may be reset by button inputs (e.g., a user pressing a physical button on the UI of the device), and the first user inactivity subsystem may perform a first set of inactivity timeout functions in response to expiration of the first timer. In contrast, a second user inactivity timer of a second user inactivity subsystem may be reset by touch screen inputs, and the second user inactivity subsystem may perform a second set of inactivity timeout functions in response to expiration of the second timer.

Because each processor may detect different sets of user inputs events, an application executed by a first processor may time out even though user input events have been detected by a second processor. The conventional solution to managing user inactivity in multiprocessor devices is to transmit each user input event from the processor that detected the user input event to the other processor or processors in the communication device that may not have detected the user input event. However, this brute force method of tracking user activity causes excessive inter-processor communication (IPC) bus traffic, which in turn leads to increased power drain on the communication device and processing latency for more critical communications between respective processors.

Thus, there is a need for improved detection and management of user inactivity in multiprocessor communication devices. One example provides a communication device including a user interface (UI); a first electronic processor configured to detect and process UI input events; and a second electronic processor communicatively connected to the first electronic processor and configured to detect and process UI input events, wherein the first electronic processor is further configured to execute a first application having a user inactivity timeout feature by initializing a countdown timer for a first time period, in response to expiration of the countdown timer, determining a user inactivity time for the communication device, the user inactivity time being a lesser of a time since a UI input event was last detected by the first electronic processor and a time since a UI input event was last detected by the second electronic processor, and in response to the user inactivity time being greater than or equal to the first time period, performing a first application timeout function that includes at least one selected from the group consisting of disabling a UI feature of the first application, providing an alert to the UI that a user inactivity timeout has occurred, transmitting an alert to an external device that a user inactivity timeout has occurred, and entering a power saving state.

In some aspects, the first electronic processor is configured to determine the time since a UI input event was last detected by the second electronic processor by, in response to expiration of the countdown timer, transmitting a request to the second electronic processor for the time since a UI input event was last detected.

In some aspects, the first electronic processor is further configured to, in response to the user inactivity time being less than the first time period, reinitialize the countdown timer for a first delta time period, the first delta time period being a difference between the first time period and the user inactivity time.

In some aspects, the first electronic processor is further configured to in response to expiration of the reinitialized countdown timer, determine an updated user inactivity time, and in response to the updated user inactivity time being greater than or equal to the first time period, perform the first application timeout function.

In some aspects, the second electronic processor is further configured to execute a second application having a user inactivity timeout feature by initializing a second countdown timer for a second time period, in response to expiration of the second countdown timer, determining the user inactivity time for the communication device, the user inactivity time being a lesser of a time since a UI input event was last detected by the first electronic processor and a time since a UI input event was last detected by the second electronic processor, and in response to the user inactivity time being greater than or equal to the second time period, perform a second application timeout function.

In some aspects, the first electronic processor is further configured to, in response to detecting a UI input event, generate and store a timestamp associated with the detection.

In some aspects, the first electronic processor is further configured to, during execution of a second application by the second electronic processor from the second electronic processor, receive a request for the time since a UI input event was last detected by the first electronic processor, and in response to receiving the request, transmit, to the second electronic processor, a response indicative of the time since a UI input event was last detected by the first electronic processor.

In some aspects, the first application is stored in a first memory and the second application is stored in a second memory different from the first memory.

In some aspects, a UI input event detected by the first electronic processor or the second electronic processor includes at least one selected from the group consisting of a touch screen event, a button press event, a knob movement event, an accessory connection event, and a communication device movement event.

In some aspects, the first electronic processor is further configured to, in response to disabling a UI feature of the first application, prompt a user, via the UI, to enter a PIN to reenable the UI feature.

In some aspects, providing the alert to the user interface that the user inactivity timeout has occurred includes transmitting a command to the second electronic processor to generate the alert.

In some aspects, the communication device is a portable radio device.

In some aspects, the first electronic processor detects a different set of UI input events than the second electronic processor.

In some aspects, the first electronic processor is further configured to, in response to performing a first application timeout function, transmit, to the second electronic processor, a command to enter an immediate mode, wherein, in the immediate mode, the second electronic processor reports, to the first electronic processor, UI input events, in response to detection of the UI input events by the second electronic processor and without receiving a request from the first electronic processor, in response to detecting a UI input event or receiving, from the second electronic processor, an indication that the second electronic processor has detected a UI input event, exit the immediate mode, and reinitialize the countdown timer.

Another example provides a communication device including a user interface (UI); a first electronic processor configured to detect and process UI input events; and a second electronic processor communicatively connected to the first electronic processor and configured to detect and process UI input events, wherein the first electronic processor is further configured to execute, in a first mode of operation, an application having a user inactivity timeout feature, in the first mode, periodically determine a user inactivity time of the communication device, the user inactivity time being an amount of time that no UI input events are detected by the first electronic processor or the second electronic processor, in response to determining that the user inactivity time exceeds a first time period, perform a user inactivity timeout function and execute the application in a second mode of operation, wherein, in the second mode, the second electronic processor asynchronously reports, to the first electronic processor, UI input events detected by the second electronic processor.

In some aspects, the first electronic processor is further configured to in the second mode, in response to determining that a UI input event is detected by the first electronic processor or the second electronic processor, cancel the user inactivity timeout function and execute the application in the first mode of operation.

In some aspects, in the first mode, the first electronic processor periodically determines the user inactivity time by initializing a countdown timer for the first time period, in response to expiration of the countdown timer, determining a time since a UI input was last detected by the first electronic processor, transmitting a request to the second electronic processor for a time since a UI input event was last detected by the second electronic processor, and determining the user inactivity time as a lesser of the time since a UI input event was last detected by the first electronic processor and the time since a UI input event was last detected by the second electronic processor.

In some aspects, the first electronic processor is further configured to, in response to expiration of the countdown timer and the user inactivity time being less than the first time period, reinitialize the countdown timer for a first delta time period, the first delta time period being a difference between the first time period and the user inactivity time.

In some aspects, UI input events detected by the first electronic processor include touch screen events and UI input events detected by the second electronic processor include button press events and/or dial movement events.

Another example provides a method for a multiprocessor communication device having a user interface (UI), a first electronic processor that detects UI input events, and a second electronic processor that detects UI input events. The method includes executing, with a first electronic processor, a first application; initializing a countdown timer for a first time period; in response to expiration of the countdown timer, determining a user inactivity time for the multiprocessor communication device, the user inactivity time being a lesser of a time since a UI input event was last detected by the first electronic processor and a time since a UI input event was last detected by the second electronic processor, and in response to the user inactivity time being greater than or equal to the first time period, performing a first application timeout function that includes at least one selected from the group consisting of disabling a user interface feature of the first application, providing an alert to the user interface that a user inactivity timeout has occurred, transmitting an alert to an external device that a user inactivity timeout has occurred, and entering a power saving state.

Examples are herein described with reference to flowchart illustrations and/or block diagrams of methods, apparatus (systems) and computer program products according to examples. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some examples, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or example discussed in this specification can be implemented or combined with any part of any other aspect or example discussed in this specification.

Further advantages and features consistent with this disclosure will be set forth in the following detailed description, with reference to the figures.

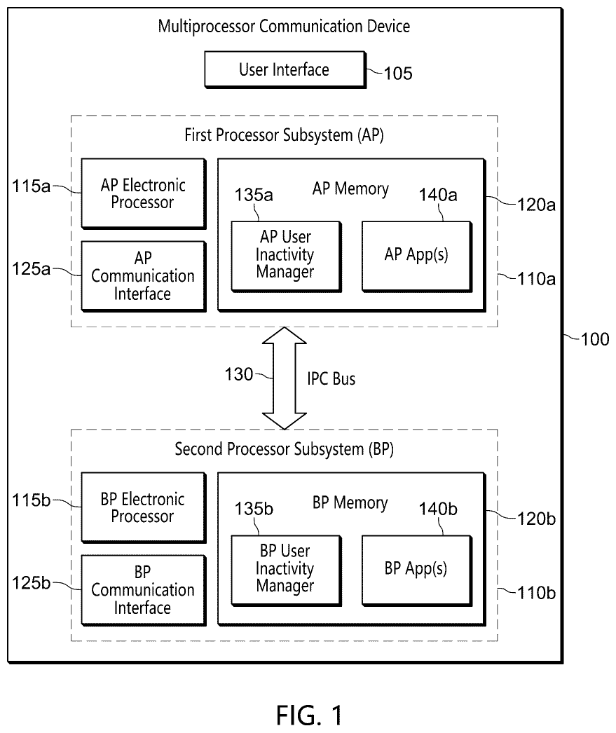

Referring now to the drawings, FIG. 1 is a block diagram illustrating a multiprocessor communication device 100, such as a portable smart radio or other mobile communication device, according to some examples. The multiprocessor communication device 100, otherwise referred to as the communication device 100, at least includes a user interface (UI) 105, a first processor subsystem 110a, and a second processor subsystem 110b. The first processor subsystem 110a is communicatively connected to the second processor subsystem 110b via an inter-processor communication (IPC) bus 130. The IPC bus 130 may be a universal asynchronous receiver/transmitter (UART) bus, a universal serial bus (USB), or other suitable communication bus.

The UI 105 may include a variety of user input and output elements including, but not limited to, a display screen (e.g., a touch screen), a microphone, a speaker (e.g., one or more speakers), one or more buttons (e.g., a push-to-talk button, volume buttons, a display sleep/wake button, a power button, an emergency alert button, custom programmable buttons, etc.), one or more dials or knobs (e.g., a volume knob, a radio frequency (RF) channel knob, etc.), a gyroscope, an accelerometer, one or more switches, accessory device connection interfaces, or a combination thereof.

In some examples, the first processor subsystem 110a is an application processor (AP) subsystem 110a. The first processor subsystem 110a, otherwise referred to herein as the AP subsystem 110a, includes an AP electronic processor 115a, an AP memory 120a, and an AP communication interface 125a. The AP memory 120a stores data and computer program instructions for performing, among other things, methods described herein. For example, the AP memory 120a may store an AP user inactivity manager 135a and one or more AP applications 140a executable by the AP electronic processor 115a. The AP communication interface 125a enables communication between the AP subsystem 110a and other components of the communication device 100, such as the second processor subsystem 110b and one or more elements of the UI 105. In some instances, the AP communication interface 125a further enables communication between the communication device 100 and an external communication device (e.g., using a broadband communication protocol and/or a land mobile radio (LMR) communication protocol).

In some examples, the second processor subsystem 110b is a baseband processor (BP) subsystem 110b. The second processor subsystem 110a, otherwise referred to herein as the BP subsystem 110b, includes a BP electronic processor 115b, a BP memory 120b, and a BP communication interface 125b. The BP memory 120b stores data and computer program instructions for performing, among other things, methods described herein. For example, the BP memory 120b may store a BP user inactivity manager 135b and one or more BP applications 140b executable by the BP electronic processor 115b. The BP communication interface 125b enables communication between the BP subsystem 110b and other components of the communication device 100, such as the AP subsystem 110a and one or more elements of the UI 105. In some instances, the BP communication interface 125b further enables communication between the communication device 100 and an external communication device (e.g., using a broadband communication protocol and/or an LMR communication protocol).

For simplicity, the communication device 100 is illustrated in FIG. 1 and described herein as including two processor subsystems 110a and 110b. However, the communication device 100 may have more than two processor subsystems 110, each including a respective user inactivity manager 135 and each connected to other processor subsystems by means of an IPC bus 130.

In some instances, the AP electronic processor 115a operates asynchronously with respect to the BP electronic processor 115b, and uses a different operating system than the BP electronic processor 115b. Because the AP electronic processor 115a and the BP electronic processor 115b other operate independently from one another, the AP electronic processor 115a and the BP electronic processor 115b rely on the IPC bus 130 to communicate with one another and to synchronize operations as needed.

The AP electronic processor 115a is electrically connected to a first set of UI elements of the UI 105, and is configured to detect and process UI input events received via the first set of UI elements. The BP electronic processor 115b is electrically connected to a second set of UI elements of the UI 105, and is configured to detect and process UI input events received via the second set of UI elements. The first set of UI input events detectable by the AP electronic processor 115a may be different from the second set of UI input events detectable by the BP electronic processor 115b. For example, the AP electronic processor 115a may be wired to detect and process touch screen input events, and the BP electronic processor 115b may be wired to detect and process certain button press and knob movement input events. However, the set of UI input events detectable by the AP electronic processor 115a may overlap with the set of UI input events detectable by the BP electronic processor 115b. For example, the AP electronic processor 115a may detect a first UI input event that is not detectable by the BP electronic processor 115b, the BP electronic processor 115b may detect a second UI input event that is not detectable by the AP electronic processor 115a, and the AP electronic processor 115a and BP electronic processor 115b may detect a third UI input event that is detectable by both processors 115a and 115b.

An AP application 140a executed by the AP electronic processor 115a may have a user inactivity timeout feature that causes the AP electronic processor 115a to perform user inactivity timeout function when no user input to the UI 105 is detected by the AP electronic processor 115a for at least a predetermined period of time. Similarly, a BP application 140b executed by the BP electronic processor 115b may also have a user inactivity timeout feature that causes the BP electronic processor 115b to perform a user inactivity timeout function when no user input to the UI 105 is detected by the BP electronic processor 115b for at least a predetermined period of time.

User inactivity timeout functions respectively performed by the AP electronic processor 115a or the BP electronic processor 115b include, for example, disabling a UI feature of the application 140 (e.g., locking a secure session in an application, locking the communication device 100), providing an alert to the UI 105 that a user inactivity timeout has occurred (e.g., providing a notification to the display screen of the communication device 100 or playing an alert tone), transmitting an alert to an external device that a user inactivity timeout has occurred, entering a power saving state (e.g., dimming or turning off the display screen), or a combination thereof.

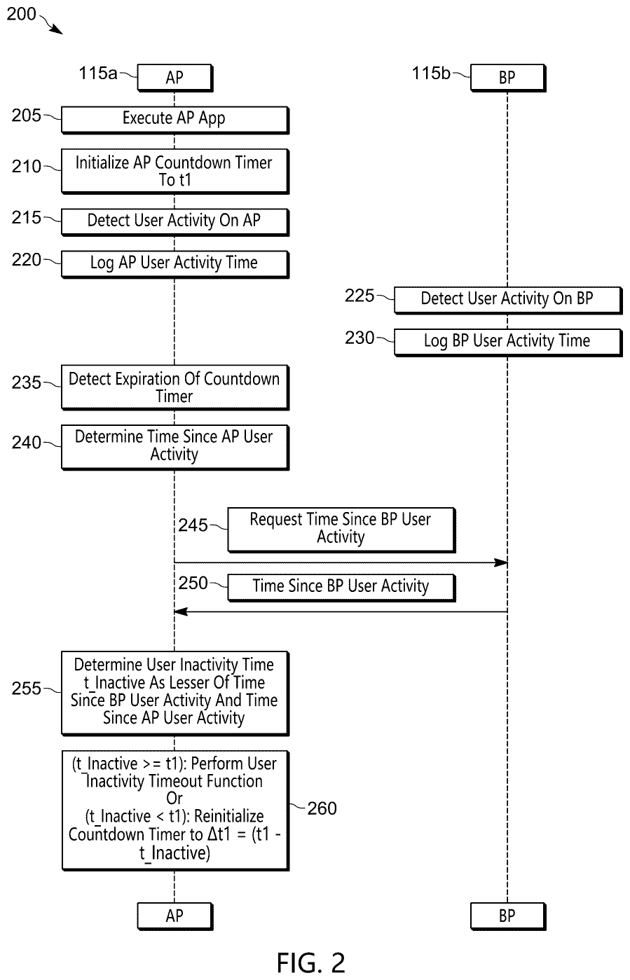

Conventionally, because the AP electronic processor 115a detects and processes a different set of user input events than the BP electronic processor 115b, a user inactivity timeout may be triggered in the AP application 140a even when user inputs are detected by the BP electronic processor 115b. Therefore, FIG. 2 illustrates a method 200 for detecting and managing, with respect to an AP application 140a executed by the AP electronic processor 115a, user inactivity in the multiprocessor communication device 100.

The method 200 includes executing, with the AP electronic processor, the AP application 140a (at block 205). The AP electronic processor 115a may also execute the AP user inactivity manager 135a in parallel with (e.g., in the background of) the AP application 140a to perform the method 200. As described above, the AP application 140a is an application having a user inactivity timeout feature.

As an example, the AP application 140a may be an application that requires a user of the communication device log into a secure session (e.g., by entering a PIN using the touch screen of the UI 105). The logged in session of the AP application 140a may expire after, for example, thirty minutes of user inactivity on the communication device 100. Accordingly, the AP electronic processor 115a initializes, for example using the AP user inactivity manager 135a, an AP countdown timer to a first time t1 (e.g., 30 minutes) (at block 210). However, the AP electronic processor 115a may initialize the AP countdown timer in response to other conditions, such as entering a particular mode in the AP application 140a, or in response to waking a particular UI element of the UI 105 (e.g. the display screen). The AP electronic processor 115a may initialize the AP countdown timer using an alarm manager service included in the operating system of the AP electronic processor 115a.

The first period of time t1 is a user inactivity timeout threshold associated with the user inactivity timeout feature. The first time t1 may be a time period other than 30 minutes, and may be less than 30 minutes or greater than 30 minutes. In some instances, the first time t1 is specific to the particular AP application 140a being executed by the AP electronic processor 115a. For example, the AP electronic processor 115a may initialize a different AP countdown timer for each AP application 140a executed by the AP electronic processor 115a.

During execution of the AP application 140a and countdown of the AP countdown timer, the AP electronic processor 115a may detect a first UI input event (e.g., a touch screen event) on the UI 105 (at block 215). In response to detecting the first UI input event, the AP electronic processor 115a logs a timestamp of the detected first UI input event (e.g., in the AP memory 120a) (at block 220). In some instances, the first UI input event is an event that is not detected by the BP electronic processor 115b.

During execution of the AP application 140a and countdown of the AP countdown timer, the BP electronic processor 115b may also detect a UI input event (e.g., a button press event) on the UI 105 (at block 225). In response to detecting the second UI input event, the BP electronic processor 115b logs a timestamp of the detected second UI input event (e.g., in the BP memory 120b) (at block 230).

In response to a detected expiration of the AP countdown timer (at block 235), the AP electronic processor 115a determines a user inactivity time t_inactive for the communication device 100. The AP electronic processor 115a determines a user inactivity time t_inactive by determining the time since a UI input event was last detected by the AP electronic processor 115a (at block 240), and transmitting a request, to the BP electronic processor 115b using the IPC bus 130, for the time since a UI input event was last detected by the BP electronic processor 115b (at block 245). The AP electronic processor 115a determines the time since a UI input event was last detected by the AP electronic processor 115a by, for example, referring to the logged user activity times in the AP memory 120a. In the illustrated example, the time since a UI input event was last detected by the AP electronic processor 115a is the time since detection of the first UI input event at block 215.

In response to transmitting the request to the BP electronic processor 115b for the time since a UI input event was last received by the BP electronic processor 115b, the AP electronic processor 115a receives, from the BP electronic processor using the IPC bus 130, a response from the BP electronic processor 115b including the logged time since a UI input event was last detected by the BP electronic processor 115b (at block 250). In the illustrated example, the time since a UI input event was last detected by the BP electronic processor 115b is the time since detection of the second UI input event at block 225. In some instances, the BP electronic processor 115b transmits, to the AP electronic processor 115a, the logged time that a UI input event was last detected by the BP electronic processor 115b, and the AP electronic processor 115a calculates the time since detection based on the received time of detection. By querying the BP electronic processor 115b only in response to expiration of the AP countdown timer rather than each time a UI input event is detected, usage of the IPC bus 130 can be substantially reduced.

As described above, in some instances, respective UI input events are detected by both the AP electronic processor 115a and the BP electronic processor 115b. In such instances, the time since a respective UI input event was last detected by the AP electronic processor 115a may be the same as the time since a respective UI input event was last detected by the BP electronic processor 115b.

The AP electronic processor 115a determines the user inactivity time, in one example, t_inactive, for the communication device 100 as a lesser of the time since a UI input event was last detected by the AP electronic processor 115a (e.g., determined at block 240) and the time since a UI input event was last detected by the BP electronic processor 115b (e.g., determine at block 250) (at block 255). As an example, when the time since a UI input event was last detected by the AP electronic processor 115a is 25 minutes, and the time since a UI input event was last detected by the BP electronic processor 115b is 20 minutes, the AP electronic processor 115a determines the user inactivity time t_inactive as 20 minutes.

Based on the determined user inactivity time t_inactive, the AP electronic processor 115a performs a user inactivity timeout function on the communication device 100 or reinitializes the AP countdown timer (at block 260). For example, in response to the user inactivity time t_inactive being greater than or equal to the starting value of the AP countdown timer (e.g., the first time t1), the AP electronic processor 115a performs the user inactivity timeout function.

The particular user inactivity timeout function may be an application-specific and/or processor-specific function. As described above, the AP electronic processor 115a may execute an AP application 140a that requires a user of the communication device 100 to log into a secure session. In response to determining that the user inactivity time t_inactive is greater than or equal to the user inactivity countdown time, the AP electronic processor 115a may perform a user inactivity timeout function that includes locking the secure session of the AP application 140a or otherwise disabling another feature of the application 140a.

In response to the user inactivity time t_inactive being less than the first time t1, the AP electronic processor 115a reinitializes the AP countdown timer to a first delta time period Δt1 that is a difference between the first time t1 and the user inactivity time t_inactive, and repeats the operations of blocks 215-260. As an example, for a first period of time t1 that is 30 minutes and a user inactivity time t_inactive that is 20 minutes, the AP electronic processor 115a reinitializes the AP countdown timer to delta time period of 10 minutes. In response to expiration of the 10 minute timer (e.g., at repetition of block 235), the AP electronic processor 115a determines, for example, an updated user inactivity time t_inactive for the communication device 100 (e.g., according to the steps of blocks 240-255). At repetition of block 260, determines whether the updated user inactivity time t_inactive is greater than or equal to the original user inactivity timeout threshold (e.g., the first period of time t1 of 30 minutes). In this manner, the AP electronic processor 115a is configured to again query user inactivity time from each electronic processor 115 in the communication device 100 at the next potential user inactivity timeout (e.g., when the communication device 100 may have gone 30 minutes without user activity).

The method 200 may include more or fewer steps than those described above with respect to FIG. 2. For example, the AP electronic processor 115a and/or the BP electronic processor 115b may detect more or fewer UI input events than illustrated in FIG. 2, and a timing of detected UI input events may vary.

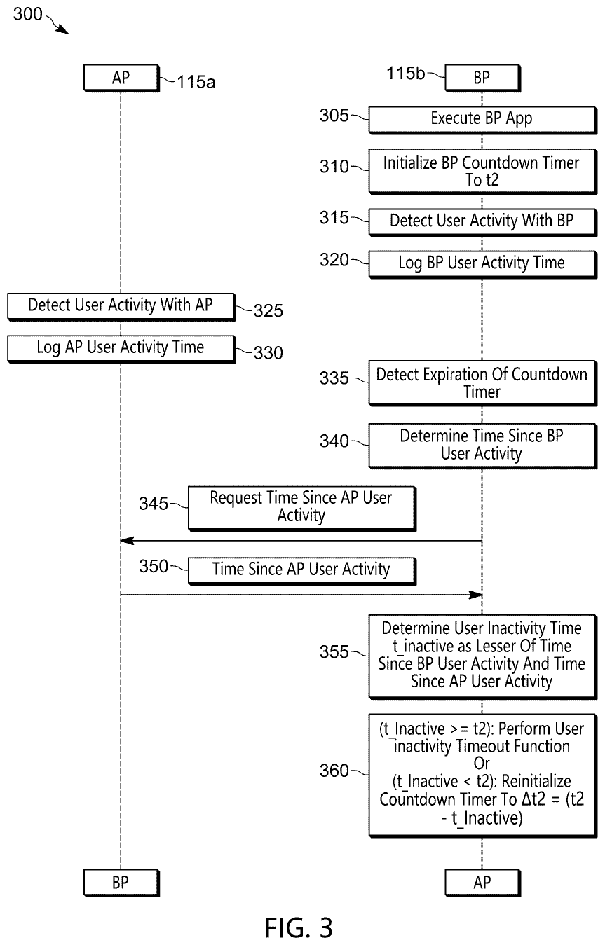

FIG. 3 illustrates a method 300 for detecting and managing, with respect to a BP application 140b executed by the BP electronic processor 115b, user inactivity in the multiprocessor communication device 100. One or more steps performed by the BP electronic processor 115b in the method 300 may be substantially similar to one or more steps performed by the AP electronic processor 115a in method 200 described above with respect to FIG. 2. One or more steps performed by the AP electronic processor 115a in the method 300 may be substantially similar to one or more steps performed by the BP electronic processor 115b in method 200. In some instances, the method 300 is performed in parallel with the method 200.

The method 300 includes executing, with the BP electronic processor, the BP application 140b (at block 305). The BP electronic processor 115b may execute the BP user inactivity manager 135b in parallel with (e.g., in the background of) the BP application 140b to perform the method 300. As described above, the BP application 140b is an application having a user inactivity timeout feature.

The user inactivity timeout feature may be similar or different from the user inactivity feature of the AP application 140a. In one example, the BP application 140b is a lone worker application for the communication device 100, and the user inactivity timeout feature is a feature that causes the BP electronic processor 115b to generate an alert when no user activity is detected on the communication device 100 for a threshold period of time.

In another example, the BP application 140b is a radio communication application, and the user inactivity timeout feature may be associated with a particular mode or operation of the radio communication application (e.g., a programming mode or a communication mode).

The BP electronic processor 115b initializes, for example using the BP user inactivity manager 135b, a BP countdown timer to a second time t2 (e.g., 15 minutes) (at block 310). The BP electronic processor 115b may initialize the BP countdown timer using an alarm manager service, for example included in the operating system of the BP electronic processor 115b.

The second period of time t2 is a user inactivity timeout threshold associated with the user inactivity timeout feature of the BP application 140b. In some instances, the BP electronic processor 115b initializes a different BP countdown timer for each BP application 140b executed by the BP electronic processor 115b. The BP countdown timer is controlled by the BP electronic processor 115b separately from the AP countdown timer controlled by the AP electronic processor 115a. Therefore, the second time t2 associated with the BP countdown timer may be the same or different from the first period of time t1 associated with the AP countdown timer and described above with respect to FIG. 2.

During execution of the BP application 140b and countdown of the BP countdown timer, the BP electronic processor 115b may detect a first UI input event (e.g., a button press event) on the UI 105 (at block 315). In response to detecting the first UI input event, the BP electronic processor 115b logs the time of the detected first UI input event (at block 320). In some instances, the first UI input event is an event that is not detected by the AP electronic processor 115a.

During execution of the BP application 140b and countdown of the BP countdown timer, the AP electronic processor 115a may also detect a UI input event (e.g., a touch screen event) on the UI 105 (at block 325). In response to detecting the second UI input event, the AP electronic processor 115a logs the time of the detected second UI input (at block 330).

In response to a detected expiration of the BP countdown timer (at block 335), the BP electronic processor 115b determines a user inactivity time t_inactive for the communication device 100. The BP electronic processor 115b determines the user inactivity time t_inactive by determining the time since a UI input event was last detected by the BP electronic processor 115b (at block 340), and transmitting a request, to the AP electronic processor 115a using the IPC bus 130, for the time since a UI input event was last detected by the AP electronic processor 115a (at block 345). The BP electronic processor 115b determines the time since a UI input event was last detected by the BP electronic processor 115b by, for example, referring to the logged user activity times in the BP memory 120b.

In response to transmitting the request to the AP electronic processor 115a for the time since a UI input event was last received by the AP electronic processor 115a, the BP electronic processor 115b receives, from the AP electronic processor using the IPC bus 130, a response from the AP electronic processor 115a including the logged time since a UI input event was last detected by the AP electronic processor 115a (at block 350). In some instances, the AP electronic processor 115a transmits, to the BP electronic processor 115b, the logged time that a UI input event was last detected by the AP electronic processor 115a, and the BP electronic processor 115b calculates the time since detection based on the received time of detection.

In some instances, the user inactivity time t_inactive is the same as the user inactivity time t_inactive described above with respect to FIG. 2. For example, the BP electronic processor 115b determines the user inactivity time t_inactive for the communication device 100 as a lesser of the time since a UI input event was last detected by the BP electronic processor 115b (e.g., determined at block 340) and the time since a UI input event was last detected by the AP electronic processor 115a (e.g., determine at block 350) (at block 355). As an example, when the time since a UI input event was last detected by the BP electronic processor 115b is 5 minutes, and the time since a UI input event was last detected by the AP electronic processor 115a is 10 minutes, the BP electronic processor 115b determines the user inactivity time t_inactive as 5 minutes.

Based on the determined user inactivity time t_inactive, the BP electronic processor 115b performs a user inactivity timeout function on the communication device 100 or reinitializes the BP countdown timer (at block 360). For example, in response to the user inactivity time t_inactive being greater than or equal to the starting value of the BP countdown timer (e.g., the second time t2), the BP electronic processor 115b performs the user inactivity timeout function associated with the BP application 140b.

The particular user inactivity timeout function may be an application-specific and/or processor-specific function. As described above in one example, the BP application 140b may be a lone worker application. In such an example, performing the user inactivity timeout function includes generating an alert that user activity has not been detected on the communication device 100 for a threshold period of time. In some instances, the alert is an auditory, vibratory, or visual alert provided to the UI 105 (e.g., via a display screen, an LED, speakers, etc.) prompting the user of the communication device 100 to interact with UI 105 (e.g., to press a button or touch the screen). In some instances, the BP electronic processor 115b transmits the alert, using the communication interface 125b, to an external communication device associated with, for example, an emergency dispatch center or other call center. In some instances, the BP electronic processor 115b transmits a command to the AP electronic processor 115a to generate the alert.

In another example described above, the BP application 140b may be a radio communication application. In such an example, performing the user inactivity timeout function may include generating an alert (e.., playing a feedback tone) that user activity has not been detected on the communication device 100 for a threshold period of time, or exiting a particular mode or feature of the BP application 140b (e.g., exiting a programming mode).

In response to the user inactivity time t_inactive being less than the first time t1, the BP electronic processor 115b reinitializes the BP countdown timer to a second delta time period Δt2 that is a difference between the second time t2 and the user inactivity time t_inactive, and repeats the operations of blocks 315-360. As an example, for a second period of time t2 that is 15 minutes and a user inactivity time t_inactive that is 5 minutes, the BP electronic processor 115b reinitializes the BP countdown timer to delta time period of 10 minutes.

The method 300 may include more or fewer steps than those described above with respect to FIG. 3. For example, the AP electronic processor 115a and/or the BP electronic processor 115b may detect more or fewer UI input events than illustrated in FIG. 3, and a timing of detected UI input events may vary.

In some instances, an application 140 is associated with multiple user inactivity timeout features. For example, as first user inactivity timeout function, the AP electronic processor 115a dims the display screen of the UI 105 in response to the user inactivity time exceeding a first timeout threshold, and, as a second user inactivity timeout function, controls the display screen to enter a sleep or off state in response to the user inactivity time exceeding a second timeout threshold. In contrast, when user activity is detected within the second timeout threshold, the AP electronic processor 115a controls the display to full brightness.

As another example of a first user inactivity timeout function, in response to the user inactivity time exceeding a first timeout threshold, the BP electronic processor 115b prompts the user of the communication device 100 to interact with the UI 105 within a second timeout threshold (e.g., one minute). In response to the user inactivity time exceeding the second timeout threshold (e.g., the user does not interact with the UI 105 within one minute), the BP electronic processor 115b performs a second user inactivity timeout function to, for example, transmit an alert to an external communication device or disable a feature of the BP application 140b. In contrast, when user activity is detected within the second timeout threshold, the BP electronic processor 115b cancels the prompt to the user for interacting with the UI 105.

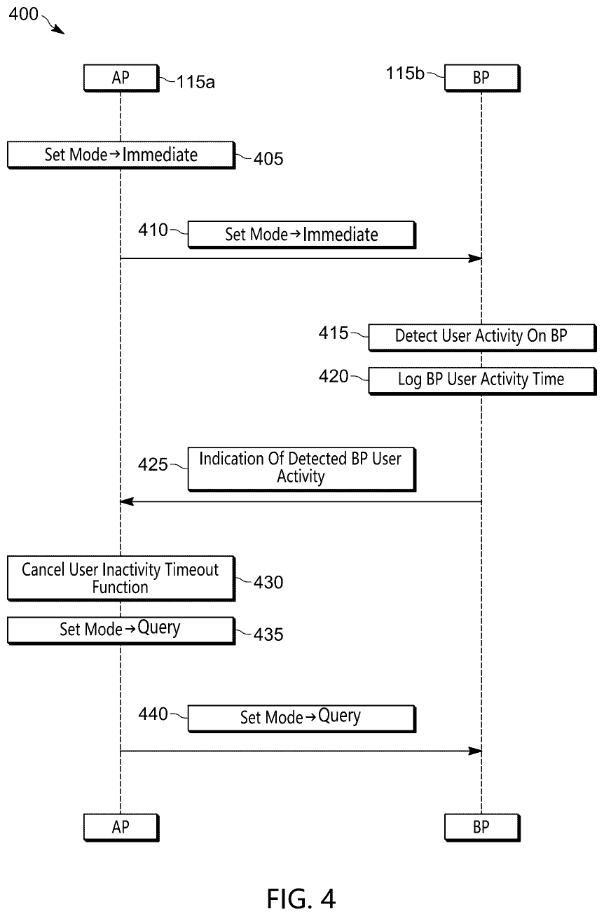

In such examples, it may be insufficient for the AP electronic processor 115a or the BP electronic processor 115b to query for user activity only in response to expiration of respective countdown timers. Therefore, FIG. 4 illustrates a method 400, described by way of example with respect to an AP application 140a, for detecting user activity in the communication device 100 in response to performing a first user inactivity timeout function. For example, in response to performing a first user inactivity timeout function (e.g., at block 260 of the method 200), the AP electronic processor 115a switches execution of the first application 140a from a first mode to a second mode (at block 405), and transmits a command to the BP electronic processor 115b to enter the second mode (at block 410).

In the first mode, otherwise referred to as a query mode, managing user inactivity during execution of the AP application 140a is substantially similar to the method 200 described above with respect to FIG. 2. In other words, in the query mode, the AP electronic processor 115a periodically determines, or queries, the user inactivity time of the communication device 100, the user inactivity time being an amount of time that no UI input events are detected by either the AP electronic processor 115a or the BP electronic processor 115b.

In the second mode, UI input events are reported asynchronously to the AP electronic processor 115a. For example, in response to detection of a UI input event by the BP electronic processor (at block 415), the BP electronic processor 115b logs the detection (at block 420) and transmits, to the AP electronic processor 115a using the IPC bus 130, an indication of the detected UI input event (at block 425). Accordingly, in the immediate mode, the BP electronic processor 115b reports respective UI input events to the AP electronic processor 115a in response to detection of the respective UI input event without receiving a request from the AP electronic processor 115a.

In response to detecting a UI input event with the AP electronic processor 115a or in response to receiving an indication from the BP electronic processor 115b that a UI input event was detected by the BP electronic processor, the AP electronic processor 115a cancels the user inactivity timeout function (at block 430). For example, the AP electronic processor 115a may disable a power saving state of the communication device 100 (e.g. return the display screen to full brightness), cancel an alert that is output using the UI 105, or cancel an alert that is transmitted to an external communication device. The AP electronic processor 115a also resets the execution mode of the AP application 140a to the query mode (at block 435), and transmits a command to the BP electronic processor to reenter the query mode (a block 440).

By switching between immediate mode and query mode as needed rather than always remaining in the immediate mode, the AP electronic processor 115a and BP electronic processor 115b are able to limit usage of the IPC bus 130 and current drain on the communication device 100.

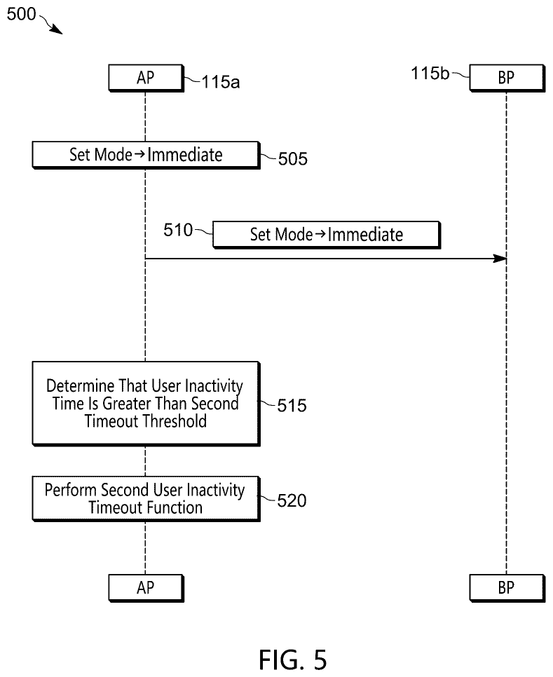

FIG. 5 illustrates a method 500, described by way of example with respect to an AP application 140a, for operation in the immediate mode according to an example where no user activity is detected in the immediate mode. As described above, an application 140 (e.g., the AP application 140a) may be associated with multiple user inactivity timeout features and multiple user inactivity timeout thresholds. Therefore, setting operation in the immediate mode (e.g., at blocks 505-510 of the method 500 or blocks 404-410 of the method 400) may include initializing a second AP countdown timer according to a second user inactivity timeout threshold. In an instance where no UI input events are detected by the AP electronic processor 115a or reported by the BP electronic processor 115b during operation in the immediate mode, the AP electronic processor 115a determines that the user inactivity time of the communication device 100 is greater than the second user inactivity timeout threshold (at block 515).

In response to determining that the user inactivity time of the communication device 100 is greater than the second user inactivity timeout threshold, the AP electronic processor 115a performs a second user inactivity timeout function (at block 520). The second user inactivity timeout function may include disabling a UI feature of the AP application 140a, providing an alert to the UI 105 that a second user inactivity timeout has occurred, transmitting an alert to an external device that a second user inactivity timeout has occurred, entering a second power saving state (e.g., further dimming or turning off the display screen), and/or the like.

While the method 400 and 500 of FIGS. 4-5 and are described for simplicity with respect to an AP application 140a executed by the AP electronic processor 115a, the methods 400 and 500 may alternatively or in addition be performed with respect to a BP application 140b executed by the BP electronic processor 115b.

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot execute mobile applications and control user interfaces, among other features and functions set forth herein).

In the foregoing specification, various examples have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if examples described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some examples may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an example can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

The terms “substantially,” “essentially,” “approximately,” “about” or any other version thereof, are defined as being close to as understood by one of ordinary skill in the art, and in one non-limiting example the term is defined to be within 10%, in another example within 5%, in another example within 1% and in another example within 0.5%. The term “one of,” without a more limiting modifier such as “only one of,” and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled,” “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A communication device comprising:
a user interface (UI);
a first electronic processor configured to detect and process UI input events; and
a second electronic processor communicatively connected to the first electronic processor and configured to detect and process UI input events,
wherein the first electronic processor is further configured to execute a first application having a user inactivity timeout feature by
initializing a countdown timer for a first time period,
in response to expiration of the countdown timer, determining a user inactivity time for the communication device, the user inactivity time being a lesser of a time since a UI input event was last detected by the first electronic processor and a time since a UI input event was last detected by the second electronic processor, and
in response to the user inactivity time being greater than or equal to the first time period, performing a first application timeout function that includes at least one selected from the group consisting of disabling a UI feature of the first application, providing an alert to the UI that a user inactivity timeout has occurred, transmitting an alert to an external device that a user inactivity timeout has occurred, and entering a power saving state.

2. The communication device of claim 1, wherein the first electronic processor is configured to determine the time since a UI input event was last detected by the second electronic processor by
in response to expiration of the countdown timer, transmitting a request to the second electronic processor for the time since a UI input event was last detected.

3. The communication device of claim 1, wherein the first electronic processor is further configured to, in response to the user inactivity time being less than the first time period, reinitialize the countdown timer for a first delta time period, the first delta time period being a difference between the first time period and the user inactivity time.

4. The communication device of claim 3, wherein the first electronic processor is further configured to
in response to expiration of the reinitialized countdown timer, determine an updated user inactivity time, and
in response to the updated user inactivity time being greater than or equal to the first time period, perform the first application timeout function.

5. The communication device of claim 1, wherein the second electronic processor is further configured to execute a second application having a user inactivity timeout feature by
initializing a second countdown timer for a second time period,
in response to expiration of the second countdown timer, determining the user inactivity time for the communication device, the user inactivity time being a lesser of a time since a UI input event was last detected by the first electronic processor and a time since a UI input event was last detected by the second electronic processor, and
in response to the user inactivity time being greater than or equal to the second time period, perform a second application timeout function.

6. The communication device of claim 1, wherein the first electronic processor is further configured to, in response to detecting a UI input event, generate and store a timestamp associated with the detection.

7. The communication device of claim 6, wherein the first electronic processor is further configured to, during execution of a second application by the second electronic processor,
receive, from the second electronic processor, a request for the time since a UI input event was last detected by the first electronic processor, and
in response to receiving the request, transmit, to the second electronic processor, a response indicative of the time since a UI input event was last detected by the first electronic processor.

8. The communication device of claim 7, wherein the first application is stored in a first memory and the second application is stored in a second memory different from the first memory.

9. The communication device of claim 1, wherein a UI input event detected by the first electronic processor or the second electronic processor includes at least one selected from the group consisting of a touch screen event, a button press event, a knob movement event, an accessory connection event, and a communication device movement event.

10. The communication device of claim 1, wherein the first electronic processor is further configured to, in response to disabling a UI feature of the first application, prompt a user, via the UI, to enter a PIN to reenable the UI feature.

11. The communication device of claim 1, wherein providing the alert to the user interface that the user inactivity timeout has occurred includes transmitting a command to the second electronic processor to generate the alert.

12. The communication device of claim 1, wherein the communication device is a portable radio device.

13. The communication device of claim 1, wherein the first electronic processor detects a different set of UI input events than the second electronic processor.

14. The communication device of claim 1, wherein the first electronic processor is further configured to
in response to performing a first application timeout function, transmit, to the second electronic processor, a command to enter an immediate mode, wherein, in the immediate mode, the second electronic processor reports, to the first electronic processor, UI input events, in response to detection of the UI input events by the second electronic processor and without receiving a request from the first electronic processor,
in response to detecting a UI input event or receiving, from the second electronic processor, an indication that the second electronic processor has detected a UI input event, exit the immediate mode, and
reinitialize the countdown timer.

15. A communication device comprising:
a user interface (UI);
a first electronic processor configured to detect and process UI input events; and
a second electronic processor communicatively connected to the first electronic processor and configured to detect and process UI input events,
wherein the first electronic processor is further configured to
execute, in a first mode of operation, an application having a user inactivity timeout feature,
in the first mode, periodically determine a user inactivity time of the communication device, the user inactivity time being an amount of time that no UI input events are detected by the first electronic processor or the second electronic processor,
in response to determining that the user inactivity time exceeds a first time period, perform a user inactivity timeout function and execute the application in a second mode of operation,
wherein, in the second mode, the second electronic processor asynchronously reports, to the first electronic processor, UI input events detected by the second electronic processor.

16. The communication device of claim 15, wherein the first electronic processor is further configured to
in the second mode, in response to determining that a UI input event is detected by the first electronic processor or the second electronic processor, cancel the user inactivity timeout function and execute the application in the first mode of operation.

17. The communication device of claim 15, wherein, in the first mode, the first electronic processor periodically determines the user inactivity time by
initializing a countdown timer for the first time period,
in response to expiration of the countdown timer, determining a time since a UI input was last detected by the first electronic processor,
transmitting a request to the second electronic processor for a time since a UI input event was last detected by the second electronic processor, and
determining the user inactivity time as a lesser of the time since a UI input event was last detected by the first electronic processor and the time since a UI input event was last detected by the second electronic processor.

18. The communication device of claim 17, wherein the first electronic processor is further configured to,
in response to expiration of the countdown timer and the user inactivity time being less than the first time period, reinitialize the countdown timer for a first delta time period, the first delta time period being a difference between the first time period and the user inactivity time.

19. The communication device of claim 15, wherein UI input events detected by the first electronic processor include touch screen events and UI input events detected by the second electronic processor include button press events and/or dial movement events.

20. A method for a multiprocessor communication device having a user interface (UI), a first electronic processor that detects UI input events, and a second electronic processor that detects UI input events, the method comprising:
executing, with a first electronic processor, a first application;
initializing a countdown timer for a first time period;
in response to expiration of the countdown timer, determining a user inactivity time for the multiprocessor communication device, the user inactivity time being a lesser of a time since a UI input event was last detected by the first electronic processor and a time since a UI input event was last detected by the second electronic processor, and
in response to the user inactivity time being greater than or equal to the first time period, performing a first application timeout function that includes at least one selected from the group consisting of disabling a user interface feature of the first application, providing an alert to the user interface that a user inactivity timeout has occurred, transmitting an alert to an external device that a user inactivity timeout has occurred, and entering a power saving state.
